(19) United States
(12) Patent Application Publication
(10) Pub. No.: US 2014/0025659 A1
(43) Pub. Date: Jan. 23, 2014

(54) SELECTING METHOD AND DEVICE THEREOF

(71) Applicant: WISTRON CORPORATION, New Taipei City (TW)

(72) Inventor: Hsi-Chun Hsiao, New Taipei City (TW)

(73) Assignee: Wistron Corporation, New Taipei City (TW)

(21) Appl. No.: 13/677,324

(22) Filed: Nov. 15, 2012

(30) Foreign Application Priority Data
Jul. 19, 2012 (TW) 101126009

(51) Int. Cl. G06F 17/30

(52) U.S. Cl. 707/722; 707/E17.014

(57) ABSTRACT

A selecting method for a multi-media device includes acquiring a target keyword; and outputting at least one selecting result according to a selecting relative net, a searching relative net and the target keyword; wherein the selecting relative net is built according to a text information and includes a plurality of selecting keywords and a plurality of selecting results, each selecting keyword of the plurality of selecting keywords corresponds to at least one of the plurality of selecting results, and the searching relative net is built according to a cloud database.

### BACKGROUND OF THE INVENTION

1. Field of the Invention

The present invention relates to a selecting method and device thereof, and more particularly, to a selecting method and device thereof for a multimedia device.

2. Description of the Prior Art

With the huge advances in multimedia technology over the past few decades, multimedia devices have become a part of modern life. Consumer multimedia products, such as televisions, stereo sets, projectors and multimedia CD players, are widely used by the public.

When a user wants to execute a specific function of a multimedia device, the user has to enter a precise instruction corresponding to the specific function in order for the specific function to be performed. For example, if a user wants to switch a television to a specific channel for watching a specific program, the user is required to enter the precise channel number of the specific channel. If the user only enters the information concerning the specific program, the user cannot switch the television to the specific channel. For example, if the user wants to watch a National Basketball Association (NBA) game, the user cannot switch the television to the corresponding sports channel via entering the term “National Basketball Association”, entering the name of a certain team in the NBA or entering the name of a particular player in the NBA.

If the goal of controlling the multimedia device to perform the specific function can be achieved by entering imprecise keywords such as information related to the specific function, the user experience can be enhanced.

### SUMMARY OF THE INVENTION

Thus, the present invention provides a selecting method and device thereof capable of associating inaccurate input information with precise selecting results.

An embodiment of the invention discloses a selecting method for a multi-media device. The selecting method includes acquiring a target keyword; and outputting at least one selecting result according to a selecting relative net, a searching relative net and the target keyword; wherein the selecting relative net is built according to a text information and includes a plurality of selecting keywords and a plurality of selecting results, each selecting keyword of the plurality of selecting keywords corresponds to at least one of the plurality of selecting results, and the searching relative net is built according to a cloud database.

An embodiment of the invention further discloses a selecting device for a multimedia device. The selecting device includes a processing unit; and a storage unit, for storing a program code instructing the processing unit to executing the following steps: acquiring a target keyword; and outputting at least one selecting result according to a selecting relative net, a searching relative net and the target keyword; wherein the selecting relative net is built according to a text information and includes a plurality of selecting keywords and a plurality of selecting results, each selecting keyword of the plurality of selecting keywords corresponds to at least one of the plurality of selecting results, and the searching relative net is built according to a cloud database.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a selecting device according to an embodiment of the present invention.

FIG. 2 is a flow diagram of a selecting method according to an embodiment of the present invention.

FIG. 3 is a schematic diagram of a selecting relative net according to an embodiment of the present invention.

FIG. 4A is a schematic diagram of a searching relative net according to an embodiment of the present invention.

FIG. 4B is a schematic diagram of determining relevant levels between searching keywords in the searching relative net.

FIG. 5 is a schematic diagram of an implementation method of the selecting method shown in FIG. 2.

FIGS. 6A-6C are schematic diagrams of combining searching relative nets built by different methods.

### DETAILED DESCRIPTION

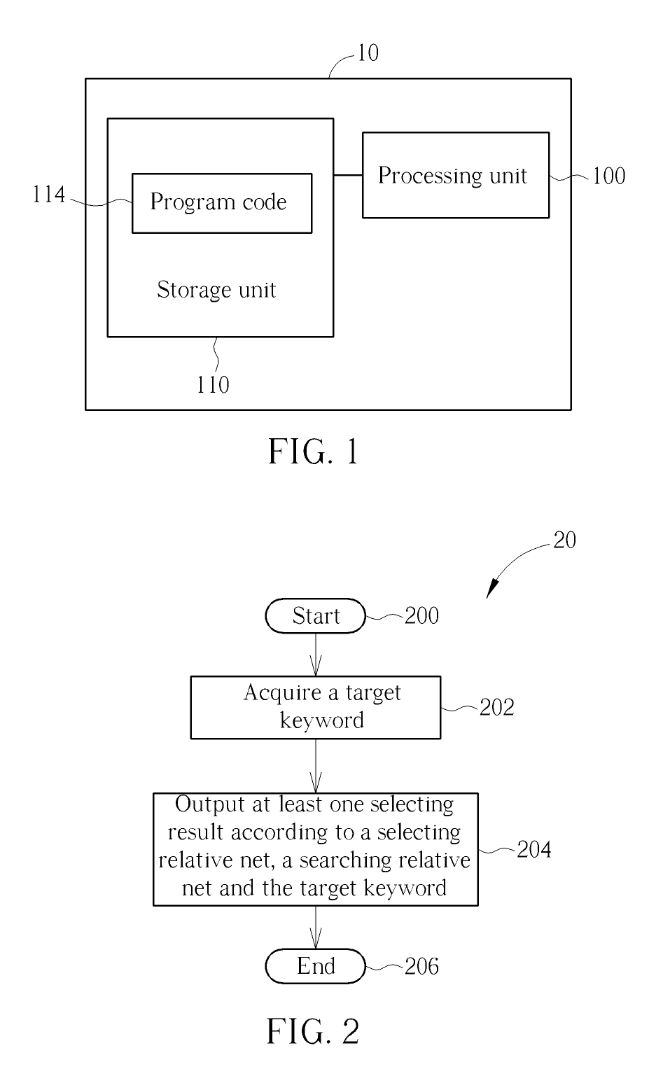

Please refer to FIG. 1, which is a schematic diagram of a selecting device 10 according to an embodiment of the present invention. The selecting device 10 may be utilized in a multi-media image system, but is not limited herein. The selecting device 10 includes a processing unit 100 such as a microprocessor or an Application Specific Integrated Circuit (ASIC) and a storage unit 110. The storage unit 110 may be any data storage device that can store a program code 114 to be accessed by the processing unit 100. Examples of the storage unit 110 include, but are not limited to, a subscriber identity module (SIM), read-only memory (ROM), flash memory, random-access memory (RAM), CD-ROM/DVD-ROM, magnetic tape, hard disk, and optical data storage device.

Please note that the spirit of the present invention is that the selecting device can output the selecting results corresponding to a target keyword according to a selecting relative net and searching relative net built by different methods after the selecting device acquires the target keyword.

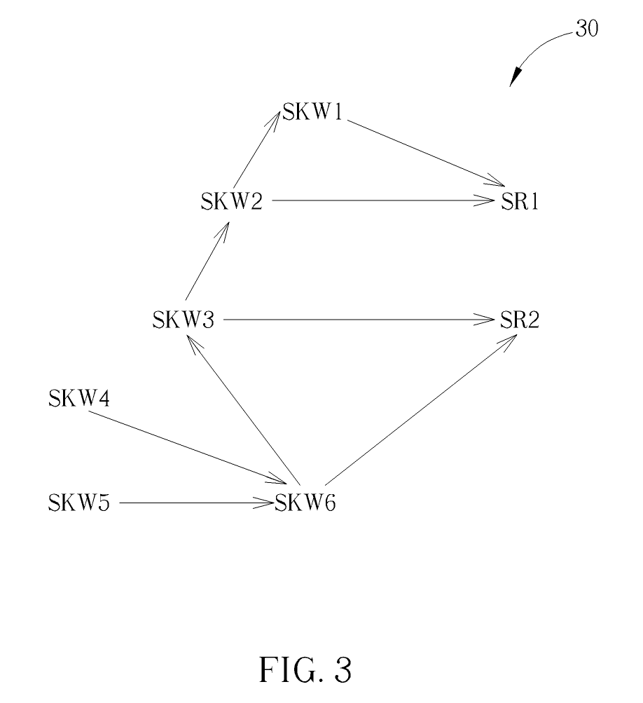

Please refer to FIG. 2, which is a flow diagram of a selecting method 20 according to an embodiment of the present invention. The selecting method 20 can be compiled into the program code 114 shown in FIG. 1 and includes the following steps:

Step 200: Start.

Step 202: Acquire a target keyword

Step 204: Output at least one selecting result according to a selecting relative net, a searching relative net and the target keyword.

Step 206: End.

According to the selecting method 20, the selecting device 10 outputs the selecting results corresponding to the target keyword through determining whether the selecting relative net and the searching relative net includes the target key word after acquiring the target keyword.

In detail, the selecting relative net can be built according to the text information, such as a television guide. Via retrieving specific keywords in the text information, the selecting relative net includes a plurality of selecting key words and a plurality of selecting results. Each selecting keyword corresponds to at least one selecting result. The selecting keyword can directly point to the selecting result or indirectly point to the selecting result corresponding to other selecting keywords by pointing to the other selecting keywords. Please note that the connection between the selecting keywords of the selecting relative net or between the selecting keywords and selecting results are uni-directional. The selecting results do not point to any selecting keyword or selecting results; this avoids the selecting device 10 entering into an infinite loop while generating the selecting results.

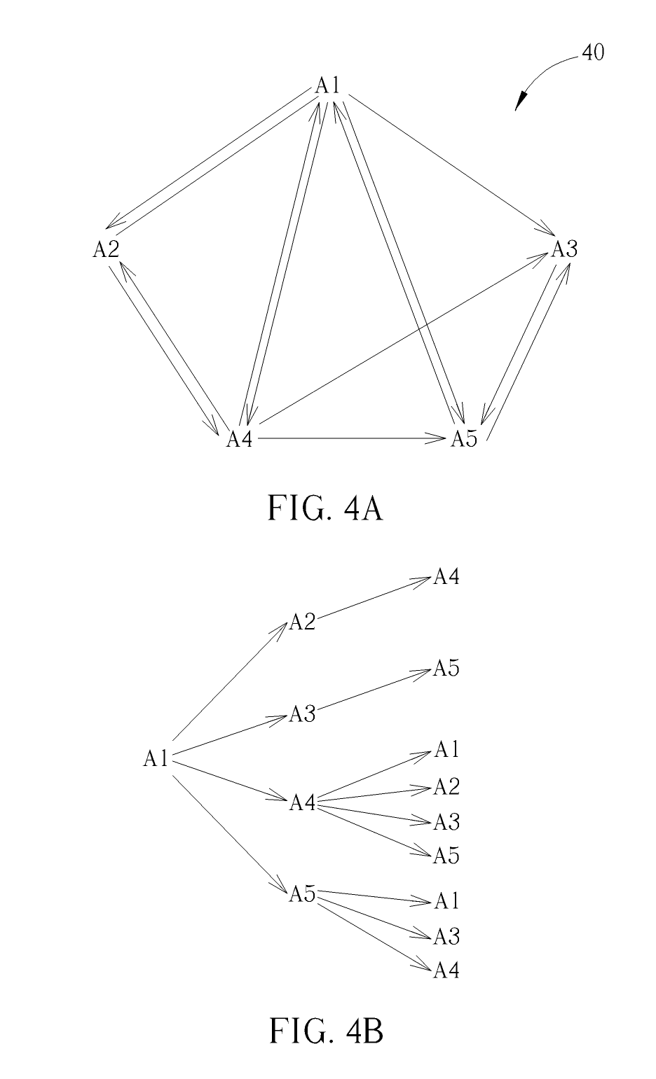

Please refer to FIG. 3 which is a schematic diagram of a selecting relative net 30 according to an embodiment of the present invention. As shown in FIG. 3, the selecting relative net 30 includes selecting keywords SKW1-SKW6 and selecting results SR1, SR2. The selecting keywords SKW1, SKW2 directly point to the selecting result SR1. The selecting keywords SKW3, SKW6 point to the selecting result SR2. The selecting keywords SKW2 also point to the selecting result SR1 via the selecting keywords SKW1. Similarly, the selecting keyword SKW3 points to the selecting result SR1 via the selecting keyword SKW2. The selecting keyword SKW6 points to the selecting results SR1, SR2 via the selecting keyword SKW3. The selecting keywords SKW4, SKW5 point to the selecting results SR1, SR2, respectively, via the selecting keyword SKW6.

The searching relative net can be built according to cloud databases, such as the GOOGLE search engine or YAHOO search engine. When the selecting device 10 inputs a searching keyword to the cloud database, the cloud database will output the other searching keywords related to the received searching keyword. In such a condition, the selecting device 10 may acquire connection relationships between searching keywords via entering the searching keywords to the cloud database. In addition, the relevant levels between the searching keywords can be determined according to the searching relative net. The following examples detail the rules of determining the relevant levels between the searching keywords.

When the selecting device 10 inputs a starting word (i.e. a searching keyword of the selecting relative net) to the cloud database, the cloud database outputs a plurality of first stage keywords related to the starting word (i.e. some of the searching keywords in the searching relative net). Next, the selecting device 10 inputs the first stage keywords to the cloud database, and then acquires a plurality of second stage keywords corresponding to each first stage keyword. If one of the second stage keyword equals the starting word, the first stage keyword corresponding to the second stage keyword which equals the starting word is highly relevant to the starting word. Otherwise, the selecting device 10 defines the first stage keyword to be weakly relevant to the starting word when all the second stage keywords corresponding to the first stage keyword do not equal to the starting word. According to the above, the selecting device 10 can determine the relevant levels between the searching keywords.

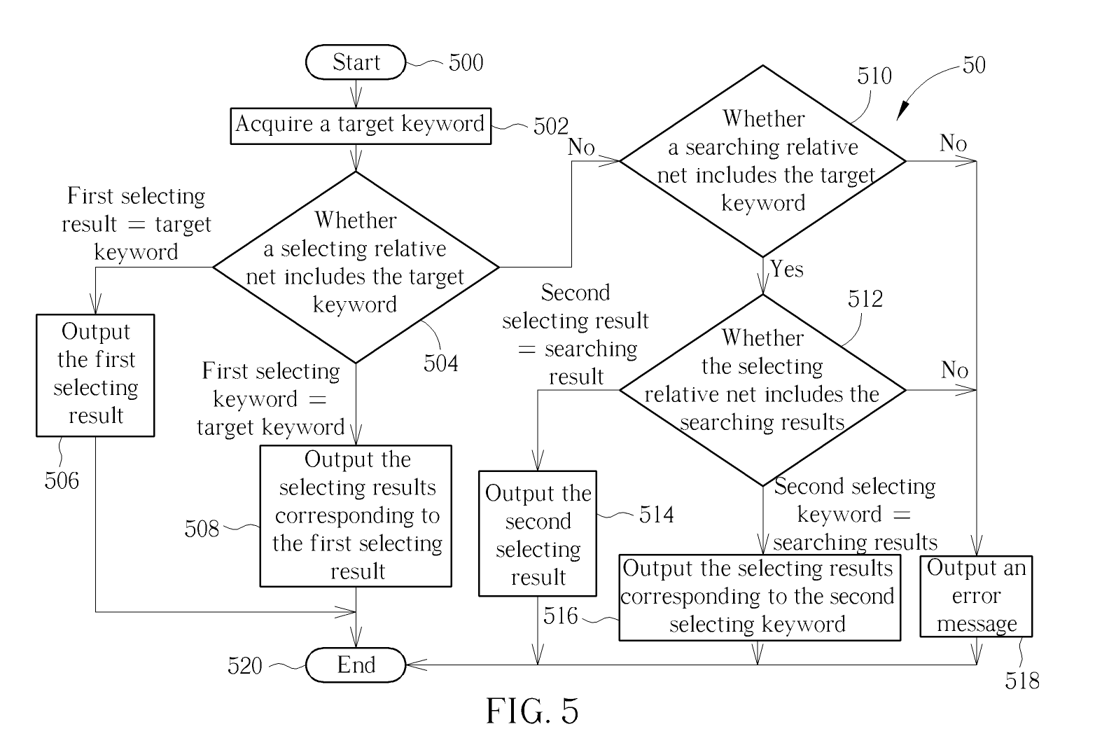

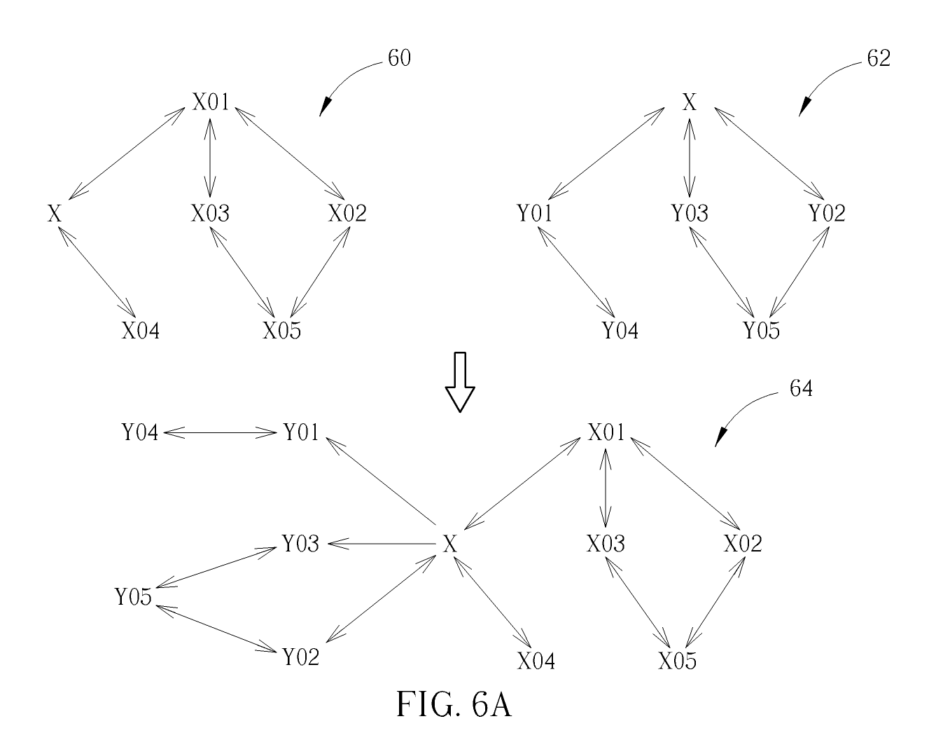

Please refer to FIG. 4A which is a schematic diagram of a searching relative net 40 according to an embodiment of the present invention. As shown in FIG. 4A, the searching relative net 40 includes searching keywords A1-A5. The searching keyword A1 points to the searching keywords A2-A5, which means that the cloud database outputs the searching keywords A2-A5 when the selecting device 10 inputs the searching keyword A1 to the cloud database. Similarly, the searching keyword A2 points to the searching keyword A4, which means that the cloud database outputs the searching keyword A4 when the selecting device 10 inputs the searching keyword A2 to the cloud database, and so on. Please refer to FIG. 4B, which is a schematic diagram of determining relevant levels between searching keyword A1 and searching keywords A2-A5. In this embodiment, the starting word is searching keyword A1. The first stage keywords of the searching keyword A1 are the searching keywords A2-A5. Since the second stage keyword corresponding to the searching keyword A2 only includes the searching keyword A4, the relevant level between the searching keyword A1 and the searching keyword A2 is weakly correlated. Similarly, the relevant level between the searching keyword A1 and the searching keyword A3 is weakly correlated. Since the second stage keywords of the searching keyword A4 include the searching keyword A1, the relevant level between the searching keyword A1 and the searching keyword A4 is highly correlated. Similarly, the relevant level between the searching keyword A1 and the searching keyword A5 is also highly correlated.

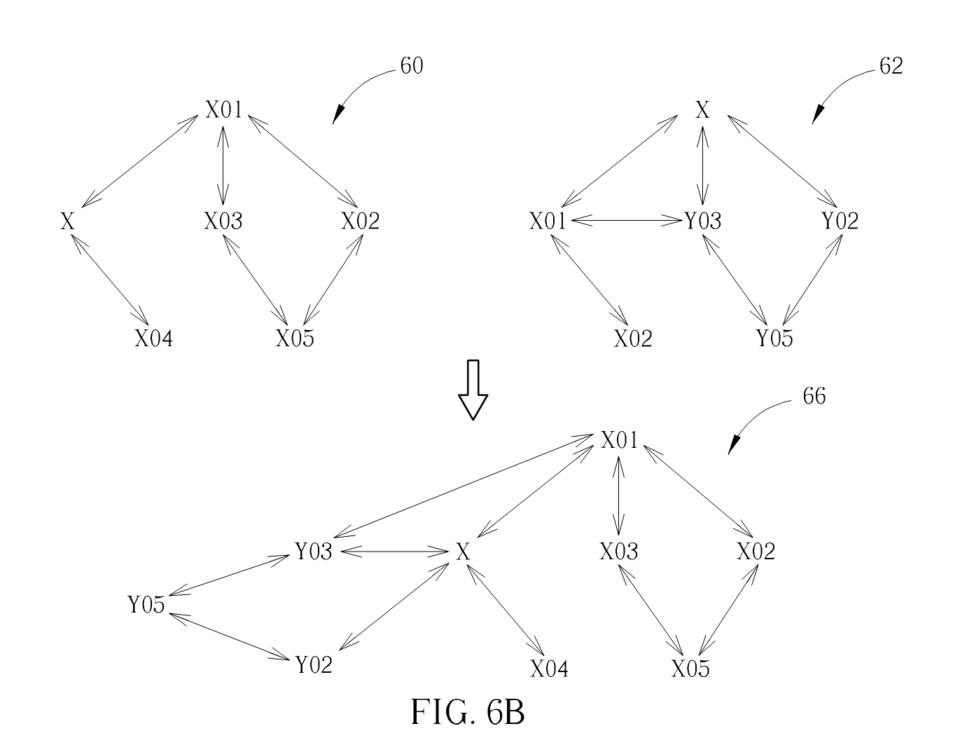

According to the selecting relative net built according to the text information and the searching relative net built according to the cloud database, the selecting device 10 can search and output specific selecting results according to the selecting method 20. Please refer to FIG. 5, which is a schematic diagram of a selecting method 50 according to an embodiment of the present invention. The selecting method 50 is an implementation of the selecting method 20 shown in FIG. 2. The selecting method 50 can be compiled to the program code 114 and includes the following steps:

Step 500: Start.

Step 502: Acquire a target keyword.

Step 504: Determine whether a selecting relative net includes the target keyword. If a first selecting result of the selecting relative net is the target keyword, perform step 506; if a first selecting keyword is the target keyword, perform step 508; and if the selecting relative net does not include the target keyword, perform the step 510.

Step 506: Output the first selecting result.

Step 508: Output the selecting results corresponding to the first selecting result.

Step 510: Determine whether a searching relative net includes the target keyword. If a first searching keyword is the target keyword, output the searching keywords highly relevant to the first searching keyword and perform step 512; otherwise, perform step 518.

Step 512: Determine whether the selecting relative net includes the searching results. If a second selecting result of the selecting relative net is one of the searching results, perform step 514; if a second selecting keyword is one of the searching results, perform step 516; and if the selecting relative net does not include any of the searching results, perform step 518.

Step 514: Output the second selecting result.

Step 516: Output the selecting results corresponding to the second selecting keyword.

Step 518: Output an error message.

Step 520: End.

According to the selecting method 50, the selecting device 10 can generate the selecting results corresponding to the target keyword according to the target keyword, the selecting relative net and the searching relative net. Please note that, since the selecting results corresponding to a selecting keyword may be plural, the selecting results corresponding to the target keyword can also be plural.

For details of the selecting method 50, please refer to the selecting relative net 30 shown in FIG. 3, the searching relative net 40 shown in FIG. 4 and the following description. After the selecting device 10 acquires a target keyword TAR in step 502, the selecting device 10 compares the target keyword TAR, the selecting keywords SKW1-SKW6 and the selecting results SR1, SR2 for determining whether the selecting relative net 30 includes the target keyword TAR in step 504. If the target keyword TAR is one of the selecting results SR1, SR2, the selecting device 10 outputs the target keyword TAR (i.e. the selecting result equaling the target keyword TAR) in step 506. If the target keyword TAR is one of the selecting keywords SKW1-SKW6, the selecting device 10 outputs the selecting results corresponding to the target keyword TAR (i.e. the selecting results corresponding to the selecting keyword equaling to the target keyword TAR) in step 508. For example, if the target keyword TAT is the selecting keyword SKW1, the selecting device 10 outputs the selecting result SR1.

Next, if the selecting relative net 30 does not include the target keyword TAR, the selecting device 10 compares the target keyword TAR and the searching keywords A1-A5 of the searching relative net 40 for determining whether the searching relative net 40 includes the target keyword TAR. If the searching keywords A1-A5 include the target keyword TAR, the selecting device 10 outputs the searching keywords highly relevant to the target keyword TAR as searching results (i.e. outputs the searching keywords highly relevant to the searching result equaling to the target keyword TAR) in step 510. The selecting device 10 starts to check whether the selecting relative net 30 includes the searching results in step 512. In this embodiment, the selecting device 10 outputs the searching keywords A4, A5 as the searching results when the target keyword TAR is the searching keyword A1. Then, the selecting device 10 starts to compares searching keywords A4, A5, the selecting keywords SKW1-SKW6 and the selecting results SR1, SR2 for determining whether the selecting relative net 30 includes the searching keywords A4, A5 (i.e. searching results).

Similar to steps 506 and 508, if a first searching result is one of the selecting results SR1, SR2, the selecting device 10 outputs the first searching result in step 514. For example, when the searching keyword A4 is one of the searching results and equal to the selecting result SR1, the selecting device 10 outputs the searching keyword A4. If a first searching result is one of the selecting keywords SKW1-SKW6, the selecting device 10 outputs the selecting results corresponding to the first searching result in step 516. For example, if the searching keyword A5 is the searching result and equal to the selecting keyword SKW1, the selecting device 10 outputs the selecting result SR1. Finally, if the selecting device 10 does not output any searching results (i.e. the searching relative net 40 does not include the target keyword TAR) or the selecting relative net 30 does not include the searching results, the selecting device 10 outputs the error message in step 518.

Please not that the main concept of the present invention is that, through the selecting relative net built according to the text information and the searching relative net built according to the cloud database, the selecting device of the present invention does not need to acquire a precise target keyword for obtaining relative selecting result. Those skilled in the art may accordingly observe appropriate alternations and modifications. For example, according to different accuracy specifications, the method of comparing the target keyword, the selecting relative net and the searching relative net can be modified. In one embodiment, while comparing the target keyword, the selecting relative net and the searching relative net, the selecting keywords, the selecting results and the searching result outputted by the selecting device of the present invention may be partially equal to the target keyword. Alternatively, the comparing progresses can be performed after capturing some words in the target keyword or re-organizing the word sequence of the target keyword.

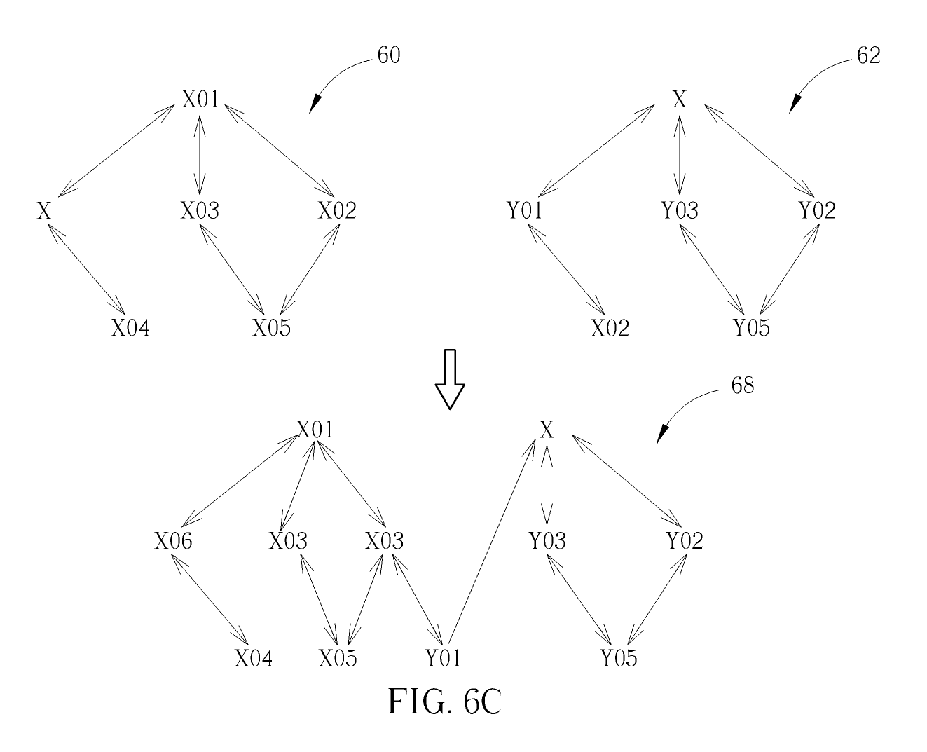

The searching relative net can be built according to the target keyword and the cloud database after acquiring the target keyword. The instantly built searching relative net, hereinafter called an instant searching relative net, may acquire the latest information from the cloud database. In comparison to the preset searching relative net, hereinafter called a built-in searching relative net, the instant searching relative net needs a longer building time and the structure of the instant searching relative net will be less complete. Thus, the selecting device of the present invention can combine the instant searching relative net and the built-in searching relative net, thereby acquiring advantages of both to build more a complete searching relative net. Please refer to FIGS. 6A-6C, which are schematic diagrams of combining the instant searching relative net and the built-in searching relative net. As shown in FIG. 6A, a built-in searching relative net 60 and an instant searching relative net 62 jointly include a target keyword X, and include different searching keywords. Thus, the built-in searching relative net 60 and the instant searching relative net 62 can be combined to be a complex searching relative net 64 based on the target keyword X. The connections of the complex searching relative net 64 are shown in FIG. 6A.

Please refer to FIG. 6B, which illustrates that the built-in searching relative net 60 and the instant searching relative net 62 not only jointly include the target keyword X, but also jointly include the searching keywords X01, X02. Thus, a complex searching net 66 can be generated via combining the built-in searching relative net 60 and the instant searching relative net 62. The connections of the complex searching relative net 66 are shown in FIG. 6B.

Please refer to FIG. 6C, which illustrates that the built-in searching relative net 60 and the instant searching relative net 62 do not jointly include the target keyword X, but jointly include the searching keyword X02. Thus, the built-in searching relative net 60 and the instant searching relative net 62 can be combined to be a complex searching relative net 68 based on the searching keyword X02. The connections of the complex searching relative net 68 are shown in FIG. 6C.

The rules of determining the relevant levels between the searching keywords of the searching relative net can be modified according to different applications. For example, the selecting device 10 may increase the searching stages when all the second stage searching keywords do not include the starting word. In other words, when the second stage searching keywords do not include the starting word, the selecting device 10 acquires a plurality of third stage keywords corresponding to each second stage keyword and then checks whether the third stage keyword includes the starting word. If the third stage searching keyword does not include the starting word, the selecting device 10 acquires a plurality of fourth stage keywords corresponding to each third stage keyword, and so on. Please note that the number of searching stages may be limited below a certain stage number for decreasing the searching time. Or, the selecting device 10 may stop searching when outputting a searching keyword as a searching result or when outputting a searching keyword existing in the selecting relative net, for reducing loading of the selecting device 10.

With an increase in the searching stages, the definition of determining a relevant level may be accordingly modified. For example, the relevant level can be determined according to the number of stages of the outputted searching keywords (ex. the first stage keyword>the second stage keyword>the third stage keyword). The relevant level between the starting word and the searching result can be a high correlation when the stage of the searching result is higher than a certain stage. The relevant level between the starting word and the searching result can be a weak correlation when the stage of searching result is below the certain stage. Moreover, the relevant level between the starting word and the searching results can also be determined by weighting method. The design and calculation of the weighting should be well known to those skilled in the art, and therefore is not narrated herein for brevity.

When the selecting results outputted by the selecting device are plural, the outputted selecting results can be chosen by the user. The selecting device can also output only one selecting result by determining the priority of the selecting result according to the selecting relative net. Please refer to FIG. 3 again. In this embodiment, the target keyword is the selecting keyword SKW3. The selecting keyword SKW3 corresponds to the selecting results SR1, SR2. According to different judging rules, the selecting device may output different selecting results. For example, since the selecting keyword SKW3 directly points to the selecting result SR2, the selecting device finally outputs the selecting results SR2. Since the selecting keyword SKW3 points to the selecting result SR2 once (i.e. selecting keyword SKW3→selecting result SR2) and the selecting keyword SKW4 points to the selecting result SR1 twice (i.e. selecting keyword SKW3→selecting keyword SKW2→selecting result SR1 and selecting keyword SKW3→selecting keyword SKW1→selecting result SR1), the selecting device outputs the selecting result SR1 in the end. In addition, the selecting device can count the number of times that each selecting result is selected by the user, for outputting the selecting result with the highest number.

To sum up, the selecting method and selecting device thereof of the present invention can output the selecting results related to the target keyword according to the target keyword, the selecting relative net built according to the text information and the searching relative net built according to the cloud database. Furthermore, the selecting method and selecting device thereof are capable of outputting precise selecting results according to inaccurate target keywords, so as to provide a more convenient user experience.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A selecting method for a multi-media device, comprising:
acquiring a target keyword; and
outputting at least one selecting result according to a selecting relative net, a searching relative net and the target keyword;
wherein the selecting relative net is built according to text information and includes a plurality of selecting keywords and a plurality of selecting results, each selecting keyword of the plurality of selecting keywords corresponds to at least one of the plurality of selecting results, and the searching relative net is built according to a cloud database.

2. The selecting method of claim 1, wherein the text information is a television guide.

3. The selecting method of claim 1, wherein a first selecting keyword of the plurality of selecting keywords singly links to a second selecting keyword and corresponds to selecting results corresponding to the second selecting keyword.

4. The selecting method of claim 1, wherein the step of outputting the selecting result according to the selecting relative net, the searching relative net and the target keyword comprises:
determining whether the plurality of selecting keywords and the plurality of selecting results of the selecting relative net comprise the target keyword, for outputting the selecting result.

5. The selecting method of claim 4, wherein the step of determining whether the plurality of selecting keywords and the plurality of selecting results of the selecting relative net comprise the target keyword, for outputting the selecting result comprises:
outputting a first selecting result as one of the selecting results when determining the target keyword equals the first selecting result.

6. The selecting method of claim 4, wherein the step of determining whether the plurality of selecting keywords and the plurality of selecting results of the selecting relative net comprise the target keyword, for outputting the selecting result comprises:
outputting the selecting result corresponding to a first selecting keyword as one of the selecting results when determining the target keyword is the first selecting keyword.

7. The selecting method of claim 1, wherein the step of outputting the selecting result according to the selecting relative net, the searching relative net and the target keyword comprises:
determining whether a plurality of searching keywords of the searching relative net comprises the target keyword, for outputting at least one searching result; and
determining whether the plurality of selecting keywords and the plurality of selecting results of the selecting relative net comprise the searching result, for outputting the selecting result.

8. The selecting method of claim 7, wherein the step of determining whether the plurality of searching keywords of the searching relative net comprises the target keyword, for outputting the searching result comprises:
outputting at least one searching keyword highly relevant to a first searching keyword of the plurality of searching keyword when the first searching keyword equals the target keyword.

9. The selecting method of claim 7, wherein the step of determining whether the plurality of selecting keywords and the plurality of selecting results of the selecting relative net comprise the searching result, for outputting the selecting result comprises:
outputting a first selecting result of the plurality selecting results as one of the selecting results when determining a first searching result of the searching result equals the first selecting result.

10. The selecting method of claim 7, wherein the step of determining whether the plurality of selecting keywords and the plurality of selecting results of the selecting relative net comprise the searching result, for outputting the selecting result comprises:
outputting selecting results corresponding to a first selecting keyword of the plurality of selecting keyword as one of the selecting results when determining a first searching result of the searching result equals the first selecting keyword.

11. A selecting device for a multi-media device, comprising:
a processing unit; and
a storage unit, for storing a program code instructing the processing unit to executing the following steps:
acquiring a target keyword; and
outputting at least one selecting result according to a selecting relative net, a searching relative net and the target keyword;
wherein the selecting relative net is built according to text information and includes a plurality of selecting keywords and a plurality of selecting results, each selecting keyword of the plurality of selecting keywords corresponds to at least one of the plurality of selecting results, and the searching relative net is built according to a cloud database.

12. The selecting device of claim 11, wherein the text information is a television guide.

13. The selecting device of claim 11, wherein a first selecting keyword of the plurality of selecting keywords singly links to a second selecting keyword and corresponds to selecting results corresponding to the second selecting keyword.

14. The selecting device of claim 11, wherein the step of outputting the selecting result according to the selecting relative net, the searching relative net and the target keyword comprises:
determining whether the plurality of selecting keywords and the plurality of selecting results of the selecting relative net comprise the target keyword, for outputting the selecting result.

15. The selecting device of claim 14, wherein the step of determining whether the plurality of selecting keywords and the plurality of selecting results of the selecting relative net comprise the target keyword, for outputting the selecting result comprises:
outputting a first selecting result as one of the selecting results when determining the target keyword equals the first selecting result.

16. The selecting device of claim 14, wherein the step of determining whether the plurality of selecting keywords and the plurality of selecting results of the selecting relative net comprise the target keyword, for outputting the selecting result comprises:
outputting the selecting result corresponding to a first selecting keyword as one of the selecting results when determining the target keyword is the first selecting keyword.

17. The selecting device of claim 11, wherein the step of outputting the selecting result according to the selecting relative net, the searching relative net and the target keyword comprises:
determining whether a plurality of searching keywords of the searching relative net comprises the target keyword, for outputting at least one searching result; and
determining whether the plurality of selecting keywords and the plurality of selecting results of the selecting relative net comprise the searching result, for outputting the selecting result.

18. The selecting device of claim 17, wherein the step of determining whether the plurality of searching keywords of the searching relative net comprises the target keyword, for outputting the searching result comprises:
outputting at least one searching keyword highly relevant to a first searching keyword of the plurality of searching keyword when the first searching keyword equals the target keyword.

19. The selecting device of claim 17, wherein the step of determining whether the plurality of selecting keywords and the plurality of selecting results of the selecting relative net comprise the searching result, for outputting the selecting result comprises:
outputting a first selecting result of the plurality of selecting results as one of the selecting results when determining a first searching result of the searching result equals the first selecting result.

20. The selecting device of claim 17, wherein the step of determining whether the plurality of selecting keywords and the plurality of selecting results of the selecting relative net comprise the searching result, for outputting the selecting result comprises:
outputting selecting results corresponding to a first selecting keyword of the plurality of selecting keyword as one of the selecting results when determining a first searching result of the searching result equals the first selecting keyword.
